(19) United States
(12) Patent Application Publication
(10) Pub. No.: US 2003/0130012 A1
(43) Pub. Date: Jul. 10, 2003

(54) Method and device for evaluating an uplink radio signal

(76) Inventors: Christhoper Brunner, Wittlich (DE); Joachim Hammerschmidt, Germering (DE)

Correspondence Address: STAAS & HALSEY LLP, 700 11TH STREET, NW, SUITE 500, WASHINGTON, DC, 20001, US

(21) Appl. No.: 10/296,473

(22) PCT Filed: May 17, 2001
(86) PCT No.: PCT/DE01/01884

(30) Foreign Application Priority Data
May 25, 2000 (DE) 100 26 076.4

(51) Int. Cl. H04B 1/38

(52) U.S. Cl. 455/562; 455/561

(57) ABSTRACT

The invention relates to a method and a device for evaluating a radio signal in a radio receiver comprising an antenna device with several antenna elements (A₁, , A_{M}), each delivering a receive signal (U₁, , U_{M}). A plurality N of first weighting vectors w^{(k,1)}, w^{(k,2)} are determined for a subscriber station (MSk). The symbols contained in a subscriber signal Iₖ which can be obtained by creating a product with the form SWU are estimated. W is the M×N matrix of the first weighting vectors, S is an N-component selection vector and U is the vector of the receive signals (U₁, , U_{M}). The selection vector is cyclically re-established in the working phase. A device for evaluating a radio signal contains inter alia a storage element (10) for storing N weighting vectors allocated to an identical transmitter (MSk) respectively, and a beam forming network (Iₖ) with a control input for the selection vector (S).

The present invention relates to a method and an apparatus for evaluating a radio signal in a receiver for a radio communication system that comprises an antenna device with a plurality of antenna elements.

Messages (voice, image information or other data) are transmitted in radio communication systems via transmission channels with the aid of electromagnetic waves (radio interface). The transmission is performed both in the downlink from the base station to the subscriber station, and in the uplink from the subscriber station to the base station.

When being propagated in a propagating medium, signals that are transmitted with the aid of electromagnetic waves are subject, inter alia, to disturbances owing to interference. Disturbances owing to noise can be produced, inter alia, by noise in the input stage of the receiver. Signal components traverse various propagation paths owing to instances of diffraction and reflection. Firstly, this has the consequence that a signal at the receiver is frequently a mixture of a plurality of contributions that certainly originate from an identical transmitted signal but which can reach the receiver variously, respectively from different directions and with different delays, attenuations and phase angles. Secondly, contributions to the received signal can interfere with each other coherently with alternating phase relations at the receiver, and lead there to extinction effects on a short-term time scale (fast fading).

The use of smart antennas, that is to say antenna arrangements with a plurality of antenna elements, in order to increase the transmission capacity in the uplink is disclosed in DE 197 12 549 A1. These permit a specific alignment of antenna gain in a direction from which the uplink signal comes.

Such antenna devices are intended to be used in cellular mobile radio communication systems, because they permit transmission channels, that is to say carrier frequencies, time slots, spread codes, etc., depending on the mobile radio communication system considered, to be allocated to a plurality of simultaneously active subscriber stations in a cell without disturbing interference arising between the subscriber stations.

Various methods for spatial signal separation for uplink and downlink directions are known from A. J. Paulraj, C. B. Papadias, “Space-time processing for wireless communications”, IEEE Signal Processing Magazine, Nov. 1997, pages 49-83.

A method is disclosed in DE 198 03 188 A in accordance with which a spatial covariance matrix is determined for a radio link from a base station to a subscriber station. In the base station, an eigenvector of the covariance matrix is calculated and used for the link as a beam-shaping vector. The transmitted signals for the connection are weighted with the beam-shaping vector and fed to antenna elements for emission. Intracell interference is not incorporated into the beam-shaping, because of the use of joint detection, for example, in the terminals, and a falsification of the received signals by intracell interference is neglected.

In descriptive terms, this method determines a propagation path with good transmission properties in an environment with multipath propagation, and concentrates the transmit power of the base station spatially onto this propagation path. However, it is not possible thereby to prevent interference on this transmission path from being able to lead in the short term to signal extinctions and thus to corruptions in the transmission.

The above-described approaches deliver advantages only in those environments in which arrival directions of the radio signals may be discerned clearly at the receiver, and in which the delays between radio signals arriving at the receiver on different propagation paths are sufficiently large. In environments where these preconditions are absent, for example in the interior of buildings, where travel time differences are short and no unambiguous source directions of the radio signals are to be discerned, these known methods do not supply any better results than in the case of reception with a single antenna. Phase fluctuations can therefore lead to short-term attenuations or extinctions of the received signal (fast fading).

Another principle of the application of antenna devices with a plurality of antenna elements in radio communication systems is known from X. Bernstein, A. M. Haimovich, “Space-Time Optimum Combining for CDMA Communications”, Wireless Personal Communications, Volume 3, 1969, pages 73 to 89, Kluwer Academic Publishers. This method assumes that extinctions of the received signal that are caused by phase fluctuations are mostly limited to small spatial regions, and so frequently not all antenna elements of an antenna device are simultaneously affected. This fact is utilized by estimating the transmission channels for each antenna element individually in short time intervals, and in a maximum ratio combiner the received signals received by the individual antenna elements and coming from the same transmitter are superimposed, and the signal thus obtained is evaluated. However, this method is not compatible with a spatial alignment of the transmission or reception characteristic of the antenna elements, that is to say the multiple use of channels for different subscriber stations, separated spatially from one another, in a cell of a radio communication system is excluded. Moreover, the effectiveness of this method is greatly limited when it is used in environments in which the radio signals arriving at the receiver can be assigned a direction. The possibility of assigning the radio signals a source direction is, specifically, equivalent to the existence of a phase correlation between the received signals received by the various antenna elements. This, in turn, means that, when an element of the antenna device is affected by an extinction of the received signal, there is a non-negligible probability that this is similar in the case of adjacent antenna elements.

It is the object of the invention to specify a method and an apparatus for evaluating a radio signal in a radio receiver with a plurality of antenna elements that, firstly, permit the reception characteristic of the receiver to be aligned in the direction of a transmitter and which is, nevertheless, protected against signal failures owing to fast fading.

This object is achieved by means of the method according to the invention having the features of patent claim 1, and the apparatus having the features of patent claim 12. Developments of the invention are to be gathered from the subclaims.

The method according to the invention is used, in particular, in a radio communication system having a base station and subscriber stations. The subscriber stations are, for example, mobile stations, as in a mobile radio network, or fixed stations, as in so-called subscriber access networks for the purpose of wireless subscriber connection. The base station has an antenna device (smart antenna) with a plurality of antenna elements. The antenna elements permit a directional reception or a directional transmission of data via the radio interface.

In the case of the method according to the invention, it is assumed that it is frequently possible in an environment with multipath propagation for the radio signal coming from an identical transmitter to be assigned a plurality of directions from which the radio signal arrives at the receiver. These directions do not change when transmitter and receiver are stationary, and, when either of the two moves, the variations effected in the received signal by this movement are small by comparison with those that are caused by fast fading. The reception characteristic of the receiver can be directed in the appropriate direction by weighting the received signals supplied by the individual antenna elements, with the components of a suitable weighting vector. Taking account of a selection vector that can vary quickly by comparison with the weighting vectors permits a dynamic adaptation to fast fading on the individual propagation paths, and “switching over” of the reception characteristic between different propagation paths, or taking simultaneous account of the contributions of different propagation paths to the received signals of the antenna elements.

In order to determine the weighting vectors, in the initialization phase a first spatial covariance matrix of the M received signals is preferably produced, eigenvectors of the first covariance matrix are determined, and the latter are used as first weighting vectors.

In order, when determining eigenvectors, to limit random influences owing to fast fading, it is expedient for the first covariance matrix to be averaged over a time period that corresponds to a multiplicity of cycles of the operating phase. In this way, falsifications in the determination of eigenvectors are averaged out by the influence of phase fluctuations.

The first covariance matrix can be produced in a standard form for the totality of the received signals received by the antenna elements. However, since the contributions of the individual transmission paths to the received signal differ not only in terms of the path covered but also in terms of the travel time required for this path, if the transmitted radio signal is a code-division multiplex radio signal, it is more informative if the first covariance matrix is produced individually for each tap of the radio signal.

In order to reduce the processing outlay, it is expedient if not all the eigenvectors of the first covariance matrix or matrices are determined, but only those that have the largest eigenvalues, because these correspond to the propagation paths with the lowest attenuation.

In accordance with a first preferred refinement of the method, a vector of so-called eigensignals is formed in the operating phase from the received signals of the antenna elements by multiplying the vector of the received signals by a matrix W whose columns (or rows) are in each case the eigenvectors determined. In other words, the received signals are weighted with all the eigenvectors determined. Each of the eigensignals thus obtained corresponds to the contribution of a transmission path to the received signals of the antenna elements. This means that the contributions delivered by the individual antenna elements are converted into contributions of individual transmission paths. The intermediary signal to be evaluated is subsequently obtained by weighting the vector, thus obtained, of eigensignals with the selection vector. The power of the eigensignals generated here in an intermediate step can be measured, and the components of the selection vector are preferably determined in each cycle as a function of the power of these eigensignals. This refinement may be implemented simply and cost-effectively, since existing receivers for smart antennas can be used for further processing of the eigensignals up to symbol estimation.

An alternative second refinement of the method provides that a second spatial covariance matrix is produced in each cycle in the operating phase, that the eigenvalues of the eigenvectors determined are calculated for the second spatial covariance matrix, and that each component of the selection vector is determined with the aid of the eigenvalue of the eigenvector corresponding to this component. This method can be implemented with a relatively low outlay on circuitry since there is no need to generate a plurality of eigensignals, and the production of covariance matrices of the received signals is required in any case in order to determine the eigenvectors.

In the case of both refinements of the method, the components of the selection vector can be determined using a maximum ratio combining method. Alternatively, all the components of the selection vector can be set equal to 0, with the exception of those that correspond to a prescribed number of respectively best transmission paths, that is to say the strongest eigensignals in the case of the first embodiment or the largest eigenvalues in the case of the second refinement. The prescribed number can in particular be 1.

The transmitter expediently periodically emits a training sequence that is known to the receiver such that the receiver can determine the first weighting vectors with the aid of the received training sequences. It is thereby possible, particularly in the case of the second refinement of the method, to produce a second covariance matrix in relation to each transmitted training sequence, and thus to update the selection vector with each training sequence. If a plurality of transmitters can communicate simultaneously with the receiver, they expediently make use of orthogonal training sequences.

An apparatus for evaluating a radio signal for a radio receiver having an antenna device with M antenna elements comprises a beam-shaping network with M inputs for received signals supplied by the antenna elements, as well as an output for an intermediary signal obtained by weighting the received signals with weighting vectors assigned to a transmitter, and a signal processing unit for estimating symbols included in the intermediary signal. It is characterized by a memory element for storing N weighting vectors respectively assigned to an identical transmitter, and the beam-shaping network has a control input for a selection vector whose components determine the contribution of each individual weighting vector to the intermediary signal.

The weighting vectors are preferably eigenvectors of a first covariance matrix produced with the aid of the M received signals. In accordance with a first preferred refinement of the apparatus, the beam-shaping network comprises two stages, the first stage comprising N branches for weighting the received signals with in each case one of the N weighting vectors, and the second stage weighting the eigensignals, supplied by the N branches, with the selection vector. Such an apparatus may be implemented in a particularly simple way, since the second stage of the beam-shaping network in conventional apparatuses for evaluating radio signals of the type described in Bernstein and Haimovich, op. cit., are already present, but are provided there for evaluating individual antenna element signals, not for evaluating eigensignals. The first refinement of the invention differs from such a conventional apparatus essentially in the addition of the first stage of the beam-shaping network and the type of production of the selection vector.

In accordance with a second refinement, the beam-shaping network comprises an arithmetic-logic unit for forming the product of the beam-shaping vector and the above-mentioned matrix W of the eigenvectors, the product obtained being used as a weighting vector in the beam-shaping network. The beam-shaping network is of particularly simple design in this refinement, since it need have only one stage.

Exemplary embodiments are explained in more detail below with the aid of the drawing, in which:

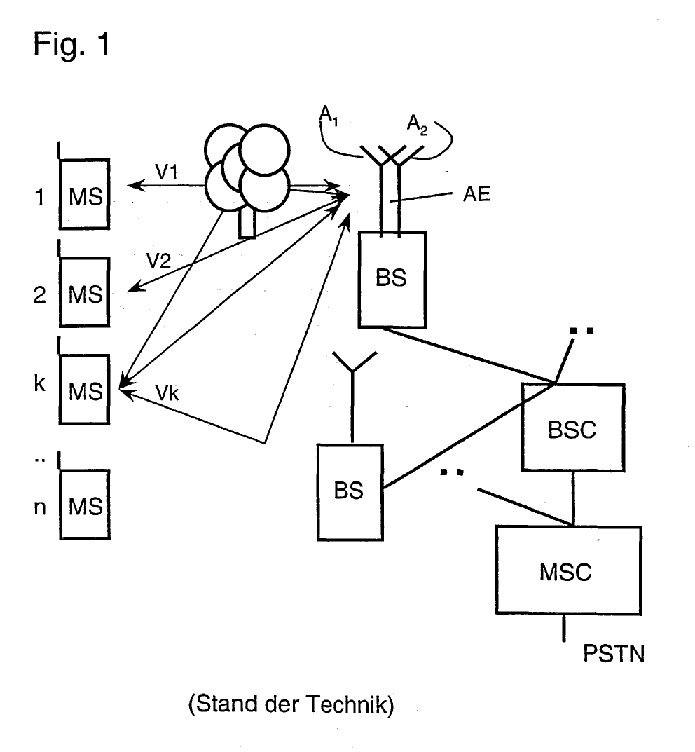

FIG. 1 shows a block diagram of a mobile radio network;

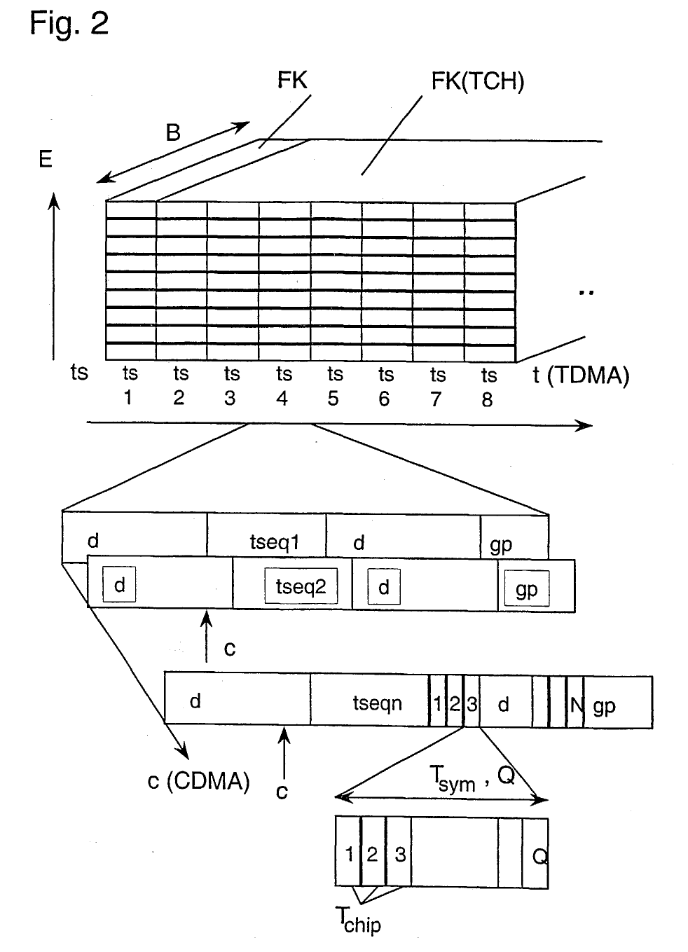

FIG. 2 shows a schematic of the frame structure of the code-division multiplex (CDMA) radio transmission;

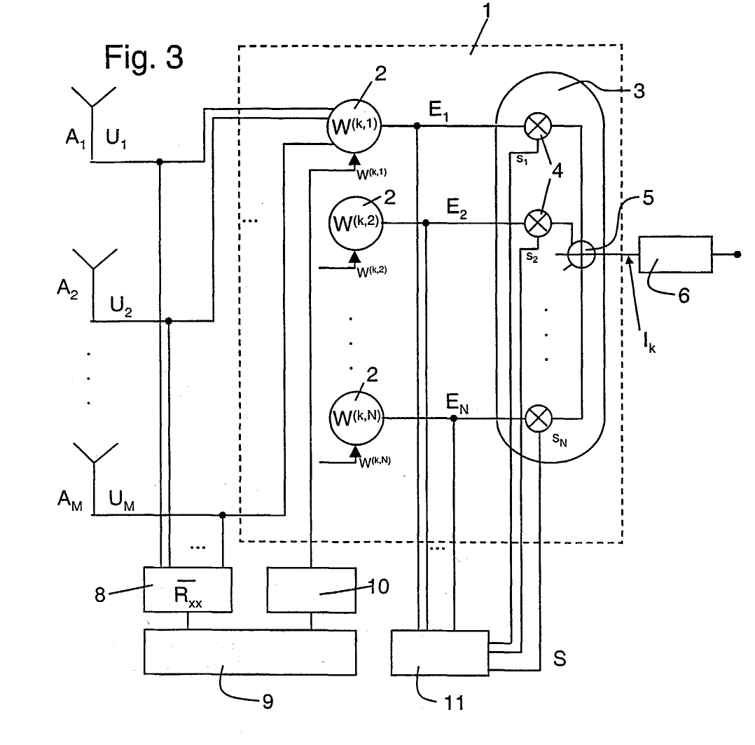

FIG. 3 shows a block diagram of a base station of a radio communication system having an apparatus for evaluating a radio signal in accordance with a first refinement of the invention;

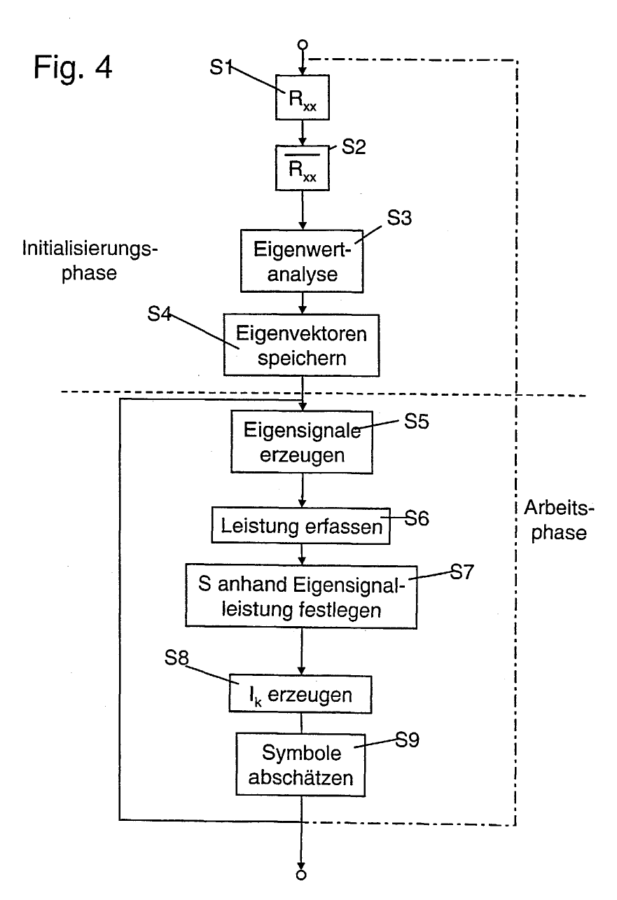

FIG. 4 shows a flowchart of the method carried out by the apparatus;

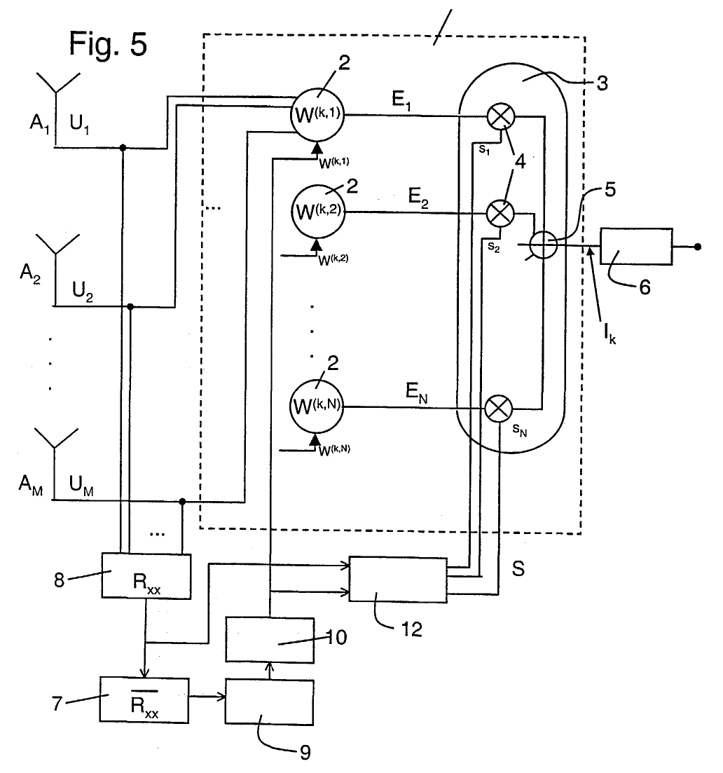

FIG. 5 shows a block diagram of a base station of a radio communication system having an apparatus for evaluating a radio signal in accordance with a second refinement of the invention;

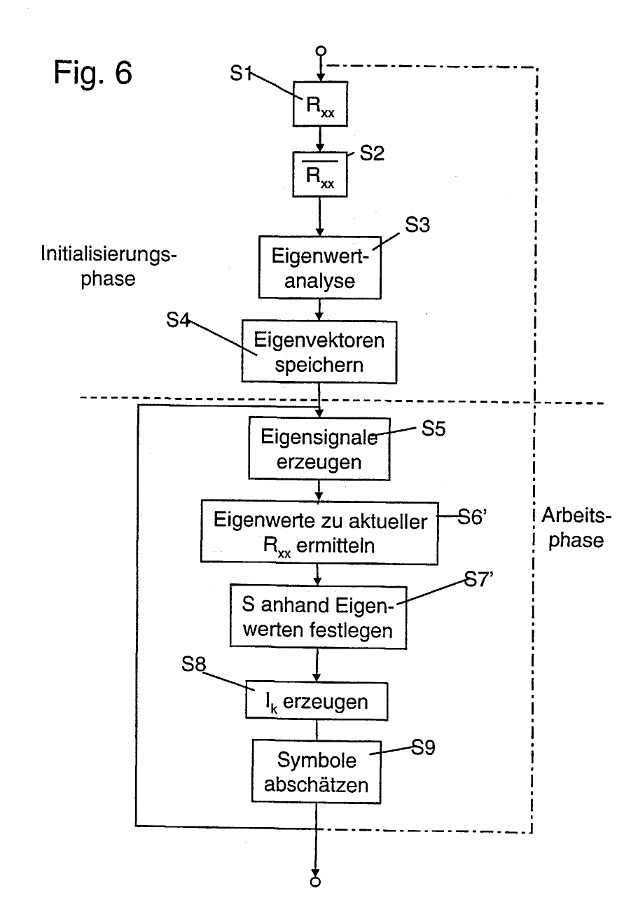

FIG. 6 shows a flowchart of the method carried out by the apparatus;

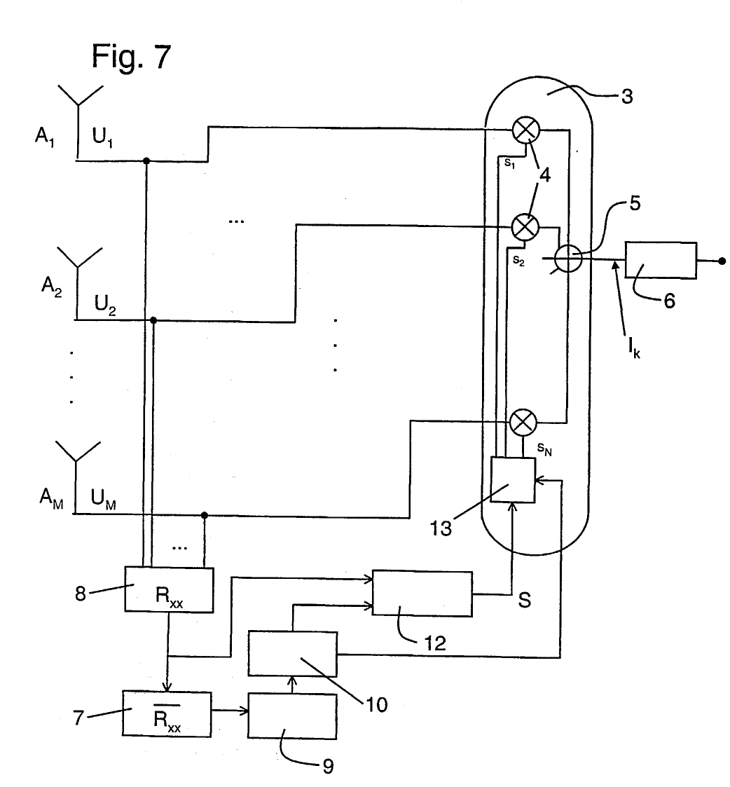

FIG. 7 shows a block diagram of a base station of a radio communication system having an apparatus for evaluating a radio signal in accordance with a third refinement of the invention; and

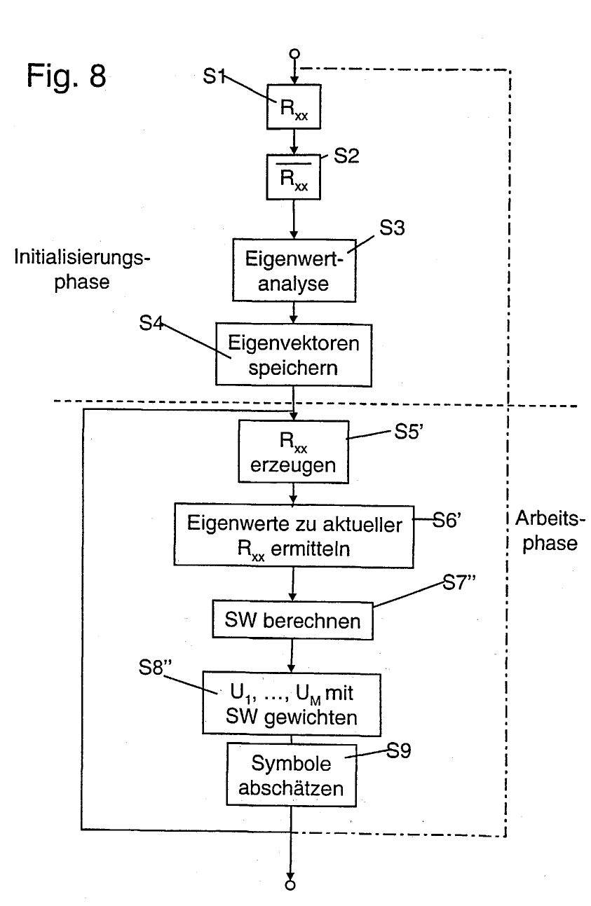

FIG. 8 shows a flowchart of the method carried out by the apparatus.

FIG. 1 shows the structure of a radio communication system, in the case of which the method according to the invention and the apparatus according to the invention can be applied. It comprises a multiplicity of mobile switching centers MSC, which are networked with one another and produce the access to a fixed network PSTN. Furthermore, these mobile switching centers MSC are connected in each case to at least one base station controller BSC. Each base station controller BSC in turn permits a connection to at least one base station BS. Such a base station BS can set up a communication link to subscriber stations MS via a radio interface. For this purpose, at least individual ones of the base stations BS are equipped with antenna devices AE which have a plurality of antenna elements (A₁-A_{M}).

By way of example, FIG. 1 shows links V1, V2, Vk for transmitting user information and signaling information between subscriber stations MS1, MS2, MSk, MSn and a base station BS. The link between the base station BS and the subscriber station MSk, considered below as representative of all subscriber stations, comprises a plurality of propagation paths, illustrated in each case by arrows.

An operation and maintenance center OMC implements control and maintenance functions for the mobile radio network, or for parts thereof.

The functionality of this structure can be transferred to other radio communication systems in which the invention can be used, in particular for subscriber access networks with wireless subscriber connection.

The frame structure of the radio transmission may be seen from FIG. 2. In accordance with a TDMA component, it is provided to divide a broadband frequency range, for example the broadband B=1.2 MHz, into a plurality of time slots ts, for example 8 time slots ts1 to ts8. Each time slot ts within the frequency range B forms a frequency channel FK. Information from a plurality of links is transmitted in radio blocks within the frequency channels TCH which are provided solely for user data transmission.

These radio blocks for user data transmission comprise sections with data d, in which sections with training sequences tseq1 to tseqn known at the receiving end are embedded. The data d are spread in a link-specific fashion with a fine structure, a subscriber code c, such that, for example n links can be separated at the receiving end by these CDMA components.

The spreading of individual symbols of the data d has the effect that Q chips of duration T_{chip} are transmitted within the symbol duration T_{sym}. The Q chips in this case form the link-specific subscriber code c. Moreover, a guard time gp for compensating different signal travel times of the links is provided within the time slot ts.

The consecutive time slots ts are organized according to a frame structure within a broadband frequency range B. Thus, eight time slots ts are combined to form a frame, for example a time slot ts4 of the frame forming a frequency channel for signaling FK or a frequency channel TCH for user data transmission, the latter channel being used recurrently by a group of links.

FIG. 3 shows a strongly schematic block diagram of a base station of a W-CDMA radio communication system that is equipped with an apparatus according to the invention for evaluating the uplink radio signal received from a subscriber station MSk, as well as, if appropriate, the uplink radio signals of other subscriber stations. The base station comprises an antenna device with M antenna elements A₁, A₂ . . . , A_{M}, which respectively supply a received signal U₁ . . . U_{M}. A beam-shaping network 1 comprises a multiplicity of vector multipliers 2 of which each receives the M received signals U₁ . . . U_{M} and forms the scalar product of this vector of the received signals with a weighting vector w^{(k,1)}, . . . , w^{(k,N)}.These weighting vectors are denoted below as eigenvectors. The number N of the eigenvectors or the multipliers 2 is exactly equal to or less than the number M of the antenna elements.

The output signals E₁, . . . E_{N} supplied by the vector multipliers 2 are denoted as eigensignals of the subscriber station MSk.

The vector multipliers 2 form a first stage of the beam-shaping network 1; a second stage is formed by a vector multiplier 3 whose internal structure is illustrated in the figure and also represents the structure of the vector multiplier 2. It has N inputs for the N eigensignals E₁, . . . E_{N}, as well as corresponding inputs for N components of a selection vector S. Scalar multipliers 4 multiply each eigensignal by the assigned component sₙ of the selection vector S. The products obtained are added up by an adder 5 to form a single so-called intermediary signal Iₖ which is fed to an estimation circuit 6 for estimating the symbols included in the received signals. The structure of the estimation circuit 6 is known per se and not part of the invention, for which reason it is not described further here.

A signal processor 8 is likewise connected to the received signals U₁, . . . U_{M} and produces covariance matrices Rₓₓ of these received signals, for example by evaluating the training sequences which are transmitted cyclically by the subscriber station MSk, that is to say in each time slot allocated to it, and are known to the signal processor 8. The covariance matrices thus obtained are averaged by the signal processor 8 over a large number of cycles. The averaging can extend over a period of from a few seconds to minutes.

The averaged covariance matrix \overline{Rₓₓ}, here also denoted as first covariance matrix, is passed on to a first arithmetic-logic unit 9 that determines the eigenvectors of the averaged covariance matrix \overline{Rₓₓ}. If it is possible for the uplink signal arriving at the antenna device of the base station to be assigned propagation paths with different arrival directions at the base station BS, an eigenvector corresponds to each of these propagation paths. The averaged covariance matrix is a matrix with M rows and columns, and it can therefore have at most M eigenvectors, of which, however, some can be trivial or can correspond to transmission paths that make no appreciable contribution to the received signal. Particularly when the number of the antenna elements M is greater than 3, executing the invention does not require all the eigenvectors of the covariance matrix to be determined; the number N of the eigenvectors determined by the first arithmetic-logic unit 9 can be less than M.

If it is determined that N is less than M, the first arithmetic-logic unit 9 averages those N eigenvectors w^{(k,1)}, . . . , w^{(k,N)} of the averaged covariance matrix \overline{Rₓₓ} that, among the totality of their eigenvectors, have the eigenvalues of greatest magnitude.

A storage element 10 serves to store these eigenvectors w^{(k,1)}, . . . , w^{(k,N)}. It is connected to the vector multipliers 2 in order to supply each of these with the eigenvector assigned to it.

The storage element 10 is illustrated in the figure as a standard component; however, it can also comprise a plurality of registers of which each records an eigenvector and is connected to the corresponding vector multiplier 2 to form a circuit unit.

The eigensignals E₁, . . . , E_{N} generated by the vector multipliers 2 correspond in each case to the contributions that are made by a single transmission path to the total uplink radio signal received by the antenna device AE. The power of these individual contributions can, vary strongly because of phase fluctuation in the individual transmission paths in short periods of the order of magnitude of the time interval between consecutive time slots of the subscriber station MSk, and signal extinction on individual transmission paths can occur. Since the various transmission paths are, however, independent of one another, the probabilities of signal extinction on the different transmission paths is uncorrelated. It follows that the probability of all N eigensignals vanishing at the same time and interruption of reception occurring is therefore less than in the case of the received signals of N antenna elements, since in the case of the latter the failure probabilities are correlated because of the close spatial proximity of the antenna elements which usually occurs.

A second stage of the beam-shaping network combines the N eigensignals to form an intermediary signal Iₖ. This second stage comprises a second signal processor 11, which is connected to the outputs of the vector multipliers 2, in order to detect the powers of the eigensignals and to produce a selection vector S for driving the vector multiplier 3. In accordance with a simple refinement, the second signal processor 11 produces a selection vector S with only one non-vanishing component, which is fed to that scalar multiplier 4 which receives the strongest eigensignal. In accordance with a preferred variant, the second signal processor 11 uses a maximum ratio combining method, that is to say it selects the coefficients s₁, . . . , s_{N} of the selection vector S as a function of the powers of the eigensignals E₁, . . . , E_{N} in such a way that, by adding the eigensignals E₁, . . . , E_{N} which are weighted with the components of the selection vector S, the intermediary signal Iₖ with the optimum signal-to-noise ratio is obtained.

FIG. 4 uses a flowchart to illustrate the method executed by the apparatus of FIG. 3. In step S1, a current covariance matrix Rₓₓ is produced with the aid of the training sequence transmitted in a time slot by the subscriber station MSk. This current covariance matrix Rₓₓ is used in step S2 to form an averaged covariance matrix \overline{Rₓₓ}. The averaging can be performed by adding up all the current covariance matrices Rₓₓ over a given time interval or a given number of cycles or time slots of the subscriber station, and dividing the sum obtained by the number of the added covariance matrices. By contrast, however, a sliding averaging is more favorable, because it does not necessarily require the acquisition of a large number of current covariance matrices Rₓₓ before an averaged covariance matrix is to hand for the first time, and because in the case of such an averaging the greatest consideration is given in each case to the most recent current covariance matrices, i.e. those covariance matrices Rₓₓ that are expected to reproduce most importantly the directions of the individual propagation paths given a moving subscriber station.

An eigenvector analysis of the averaged covariance matrix \overline{Rₓₓ} follows in step S3. After the eigenvectors obtained have been stored (step S4), the initialization phase of the method is concluded.

In the operating phase of the method, the eigensignals E₁, . . . , E_{N} are generated in step S5 with the aid of the eigenvectors w^{(k,1)}, . . . , w^{(k,N)} thus obtained. The generation of these eigensignals corresponds to the matrix multiplication. E=WU, in which case

$$E = ( \begin{matrix}{E}_{1} \\ {E}_{2} \\ ⋮ \\ {E}_{N}\end{matrix} ) , W = ( \begin{matrix}{w}_{1}^{( k , 1 )} & {w}_{2}^{( k , 1 )} & ⋯ & {w}_{M}^{( k , 1 )} \\ {w}_{1}^{( k , 2 ) } & {w}_{2}^{( k , 2 )} & & {w}_{M}^{( k , 2 )} \\ ⋮ & & ⋰ & ⋮ \\ {w}_{1}^{( k , N )} & {w}_{2}^{( k , N )} & ⋯ & {w}_{M}^{( k , N )}\end{matrix} ) , U = ( \begin{matrix}{U}_{1} \\ {U}_{2} \\ ⋮ \\ {U}_{M}\end{matrix} )$$

represent the vector of the eigensignals, the matrix of the eigenvectors and the vector of the received signals, respectively.

The power of the eigensignals E₁, . . . , E_{N} is detected in step S6, and is used in step S7 to determine the selection vector

S=(s₁ s₂ . . . s_{N}).

The generation of the intermediary signal Iₖ in step S8 therefore corresponds finally to the formation of the product

Iₖ=SWU,

the fast updating of the selection vector S as a function of the strengths of the eigensignals E₁, . . . , E_{N} permitting a fast adaptation to the fast fading of the individual transmission paths.

FIG. 5 shows a second refinement of the apparatus according to the invention. It differs from the apparatus of FIG. 3 essentially in that the first signal processor 8 in each case produces current covariance matrices Rₓₓ for every training sequence received by the subscriber station MSk, and outputs them to an averaging circuit 7 for producing the averaged covariance matrix \overline{Rₓₓ}, on the one hand, and to a second arithmetic-logic unit 12 on the other hand. This second arithmetic-logic unit 12 further receives from the storage element 10 the matrix W of the eigenvectors—determined by the first arithmetic-logic unit 9—of the averaged covariance matrix Rₓₓ, and calculates the eigenvalue of each of these eigenvectors E₁, . . . , E_{N} with the aid of the current covariance matrix Rₓₓ. Like the power of the eigensignal E₁, this eigenvalue is a measure of the quality of the propagation path that is assigned to the eigenvector or eigensignal and is used by the second arithmetic-logic unit 12 in order to produce a selection vector S with the properties already described with reference to FIGS. 3 and 4. The vector multiplier 3 uses this selection vector S to combine the eigensignals E₁, . . . , E_{N} relating to the intermediary signal Iₖ, whose symbols are estimated in the estimation circuit 6.

The method executed by this apparatus is illustrated in FIG. 6 as a flowchart; it differs from the method of FIG. 4 by the steps S6, in which the eigenvalues of the eigenvectors relating to the current covariance matrix Rₓₓ are determined, and by the step S7 of determining the selection vector S with the aid of the eigenvalues.

FIG. 7 shows a third refinement of the apparatus according to the invention. The vector multipliers 2 are omitted here, and instead the received signals U₁, . . . , U_{M} are fed directly to M scalar multipliers 4 of the vector multiplier 3. The first signal processor 8, the average circuit 7, the storage element 10 and the first arithmetic-logic units 9, 12 do not differ from those of the refinement from FIG. 5. The set of the eigenvalues determined by the second arithmetic-logic unit 12 is fed as selection vector S to a selection unit 13 that simultaneously receives the matrix W of the eigenvalues from the storage element 10 and carries out a matrix multiplication

$$( {s}_{1} {s}_{2} ⋯ {s}_{N} ) ( \begin{matrix}{w}_{1}^{( k , 1 )} & {w}_{2}^{( k , 1 )} & ⋯ & {w}_{M}^{( k , 1 )} \\ {w}_{1}^{( k , 2 )} & {w}_{2}^{( k , 2 )} & & {w}_{M}^{( k , 2 )} \\ ⋮ & & ⋰ & ⋮ \\ {w}_{1}^{( k , N )} & {w}_{2}^{( k , N )} & ⋯ & {w}_{M}^{( k , N )}\end{matrix} )$$

The intermediary signal Ik obtained at the output of the vector multiplier 3 is the same as in the case of the refinement from FIG. 7, but there is a substantial simplification in the outlay on circuitry elimination of the vector multipliers 2. It is true that instead of this a matrix multiplication takes place in the second arithmetic-logic unit 12, but the processing outlay associated therewith is substantially smaller, since this matrix multiplication need be carried out only once in each cycle of the operating phase, whereas the vector multipliers 2, 3 must process a multiplicity of samples in each cycle and must therefore have a substantially higher processing rate.

The mode of operation of the refinement of FIG. 7 is illustrated in the flowchart of FIG. 8. Steps S1 to S6′ are the same as in the case of the method from FIG. 6. In the modified step S7″ the product of the selection vector S and the matrix W of the eigenvectors is calculated, and the received signals U₁, . . . , U_{M} are weighted in step S8″ with the vector thus obtained. The estimation of the symbols in step S9 is performed again in the same way as for the other refinements.

Of course, in the case of this exemplary embodiment as well, the components of the selection vector need not be identical to the set of the eigenvalues relating to the current covariance matrix Rₓₓ; the components of the selection vector S can be calculated in any suitable way with the aid of the eigenvalues, in particular all of the components with the exception of those that correspond to a given number of the respectively largest eigenvalues can be set equal to 0.

A further development of the above-described apparatuses and methods is based on the finding that the uplink signal received by the antenna device of the base station is composed of a multiplicity of contributions that differ from one another not only in their source direction or their relative phase angle at the individual antenna elements and in their attenuation, but also in their propagation times from the subscriber station MSk to the base station BS. The propagation times of the individual contributions and their relative delays can be determined in a way known per se with the aid of a rake searcher, and it is possible to generate from the uplink radio signal for each individual antenna element a plurality of received signals that are designated as taps in the case of a CDMA radio communication system and which differ from one another in that for each tap a despreading and descrambling of the uplink radio signal is based on a different skew between the uplink radio signal and the spread and scrambling code in accordance in each case with a measured delay. In accordance with the development, the current covariance matrices Rₓₓ, and consequently also the averaged covariance matrix \overline{Rₓₓ}, are produced individually for each tap. This permits an antenna device that comprises M antenna elements to be used to distinguish and take into account during evaluation more than M propagation paths which differ from one another in their respective signal delay. A substantially more detailed and more accurate evaluation of the uplink radio signal is therefore possible than when only a single covariance matrix is produced.

The number N of the eigenvectors assigned to the subscriber station MSk need not be prescribed in a fixed manner. In the case when covariance matrices Rₓₓ, \overline{Rₓₓ} are produced individually for each tap, the total number of the eigenvectors taken into account for a subscriber station can be prescribed, although the number of the eigenvectors taken into account for each individual covariance matrix can vary. For this purpose, the first step is to calculate the totality of the eigenvectors and eigenvalues for all the averaged covariance matrices of the subscriber station, and, from the totality of the eigenvectors that can belong to different taps, those that have the largest eigenvalue are determined and stored in the storage element 10. It can happen in this case that the eigenvectors of those taps that make only a slight contribution to the uplink signal remain completely out of account.

It is also possible for the number of the eigenvectors assigned overall to a subscriber station to be varied dynamically as a function of the respective transmission situation. Thus, in the case of a direct transmission path, in particular when the subscriber station does not move or moves only slowly, it is possible to advocate a reduction in the number of the eigenvectors down to N=1, the processing capacities (or vector multipliers 2 in the case of the apparatuses from FIGS. 3 and 5) thereby rendered free being added to other subscriber stations, which have poorer transmission conditions.

1. A method for evaluating a radio signal in a radio receiver that comprises an antenna device (AE) with a plurality of antenna elements (A₁ to A_{M}) that each supply a received signal (U₁, . . . , U_{M}), having the following steps:
a) determining in an initialization phase a plurality N of M-component first weighting vectors (w^{(k,1)}, w^{(k,2)}, . . . , w^{(k,N)}) for a subscriber station (MSk), and
b) estimating in an operating phase symbols included in an intermediary signal (Iₖ) that can be obtained by forming a product of the form
Iₖ=S W U,
W being the M×N matrix of the first weighting vectors (w^{(k,1)}, w^{(k,2)}, . . . , w^{(k,N)}), S being an N-component selection vector and U being the vector of the received signals (U₁, . . . , U_{M}), the selection vector S being cyclically redetermined in the operating phase.

2. The method as claimed in claim 1, characterized in that in the initialization phase a first spatial covariance matrix (\overline{Rₓₓ}) of the M received signals is produced, in that eigenvectors of the first covariance matrix (\overline{Rₓₓ}) are determined, and in that the eigenvectors determined are the first weighting vectors.

3. The method as claimed in claim 2, characterized in that the first covariance matrix (\overline{Rₓₓ}) is averaged over a time period corresponding to a multiplicity of cycles of the operating phase.

4. The method as claimed in claim 2 or 3, characterized in that the first covariance matrix (\overline{Rₓₓ}) is produced individually for each tap of the radio signal.

5. The method as claimed in claim 2, 3 or 4, characterized in that the eigenvectors determined are those from the totality of the eigenvectors of the first covariance matrix or matrices (\overline{Rₓₓ}) that have the largest eigenvalues.

6. The method as claimed in one of the preceding claims, characterized in that in the operating phase a vector E of eigensignals (E₁, . . . , E_{N}) is formed in accordance with the formula
E=W U
and in that the components of the selection vector (S) are determined in each cycle as a function of the power of the eigensignals (E₁, . . . , E_{N}).

7. The method as claimed in one of claims 2 to 5, characterized in that a second spatial covariance matrix (\overline{Rₓₓ}) is produced in each cycle in the operating phase, in that the eigenvalues of the first eigenvectors are calculated for the second spatial covariance matrix (\overline{Rₓₓ}), and in that each component of the selection vector (S) is determined with the aid of the eigenvalue of the eigenvector corresponding to this component.

8. The method as claimed in claim 6 or 7, characterized in that the components of the selection vector (S) are determined using a maximum ratio combining method.

9. The method as claimed in claim 6 or 7, characterized in that all the components of the selection vector (S) except for a prescribed number are set equal to 0.

10. The method as claimed in one of the preceding claims, characterized in that the transmitter (MSk) periodically emits a training sequence that is known to the receiver (BS) and in that the first weighting vectors are determined with the aid of the received training sequences.

11. The method as claimed in claim 10 and claim 7, characterized in that the second covariance matrix (\overline{Rₓₓ}) is produced in relation to each transmitted training sequence.

12. An apparatus for evaluating a radio signal for a radio receiver having an antenna device (AE) with M antenna elements (A₁, . . . , A_{M}), the apparatus having a beam-shaping network with M inputs for received signals (U₁, . . . , U_{M}) supplied by the antenna elements (A₁, . . . , A_{M}), as well as an output for an intermediary signal (Iₖ) obtained by weighting the received signals with weighting vectors (w^{(k,1)}, w^{(k,2)}, . . . , w^{(k,N)}) assigned to a transmitter (MSk), and a signal processing unit (6) for estimating symbols included in the intermediary signal (Iₖ), characterized in that the apparatus comprises a memory element (10) for storing N weighting vectors respectively assigned to an identical transmitter (MSk), and in that the beam-shaping network (1) has a control input for a selection vector (S) whose components determine the contribution of each individual weighting vector (w^{(k,1)}, w^{(k,2)}, . . . , w^{(k,N)}) to the intermediary signal (Iₖ).

13. The apparatus as claimed in claim 12, characterized in that the weighting vectors (w^{(k,1)}, w^{(k,2)}, . . . , w^{(k,N)}) are eigenvectors of a first covariance matrix (\overline{Rₓₓ}) produced with the aid of the M received signals (U₁, . . . , U_{M}).

14. The apparatus as claimed in claim 12, characterized in that the beam-shaping network comprises two stages, the first stage comprising N branches for weighting the received signals with in each case one of the N weighting vectors (w^{(k,1)}, w^{(k,2)}, . . . , w^{(k,N)}), and the second stage weighting the output signals (E₁, . . . , E_{N}), supplied by the N branches, with the selection vector (S).

15. The apparatus as claimed in claim 14, characterized in that the second stage is a maximum ratio combiner.

16. The apparatus as claimed in claim 12, characterized in that the beam-shaping network is an arithmetic-logic unit for forming the product S W, W being the M×N matrix of the first weighting vectors (w^{(k,1)}, w^{(k,2)}, . . . ), and S being the N-component selection vector (S).

17. The apparatus as claimed in one of claims 12 to 16, characterized in that it is part of a base station (BS) of a mobile radio communication system.
